(19) United States
(12) Patent Application Publication
(10) Pub. No.: US 2026/0307110 A1
(43) Pub. Date: Oct. 8, 2026

(54) SORTER DEVICES, DETECTION SYSTEMS OF SORTER DEVICES, AND RELATED METHODS

(71) Applicant: Cimbria S.r.l., Imola (BO) (IT)

(72) Inventor: Gian Luca Montanari, Imola (BO) (IT)

(73) Assignee: Cimbria S.r.l., Imola (BO) (IT)

(21) Appl. No.: 19/481,474

(22) PCT Filed: Feb. 23, 2024
(86) PCT No.: PCT/IB2024/051763

§ 371 Date: Nov. 4, 2025

(30) Foreign Application Priority Data
May 11, 2023 (EP) 23425023.1

(51) Int. Cl. B07C 5/342; G01N 21/64; G01N 21/85

(52) U.S. Cl. CPC B07C 5/3425; B07C 5/3422; G01N 21/6456; G01N 2021/8592

(57) ABSTRACT

A mechanism for identifying any one or more undesired elements within a collection of elements. First image data of the collection of elements is produced responsive to fluorescence resulting from light in a first wavelength band. Second image data of the collection is produced responsive to reflected/transmitted light in a second wavelength band. The first and second image data is processed to identify the any one or more undesired elements.

### CROSS-REFERENCE TO RELATED APPLICATIONS

Not applicable.

### FIELD

Embodiments generally relate to optical bulk product sorters and methods of operating the optical sorters.

### BACKGROUND

Automatic sorter devices are conventionally utilized to sort bulk products. In particular, sorter devices are typically utilized to separate specific pieces (e.g., grains) from a bulk product in order to be sorted and/or to be discarded. Sorter devices generally include a conveyor system to create a stream of the bulk product. Bulk products can include nuts, grain, seeds, or plastic pieces. The sorter device typically includes optical detection systems arranged for acquiring and analyzing images of a stream of the bulk product. The detection systems are typically configured to provide the image data to a controller, which, based on information determined from the acquired images, sends control signals to an expulsion device to remove selected pieces (e.g., grains) from the bulk product. Expulsion devices often include air nozzles for producing air jets and/or pneumatic ejectors.

### BRIEF SUMMARY

One or more embodiments include a method for identifying any undesired elements within a collection of one or more elements.

The method comprises illuminating the collection with first light in a first wavelength band, the first light causing a level of fluorescence in at least one first undesired element of the collection that is different than a level of fluorescence in any desired element of the collection; illuminating the collection with second light in a second wavelength band, the second light causing at least one second undesired element of the collection to transmit or reflect the second light differently than any desired element of the collection; generating first image data that changes responsively to an amount of fluorescent light produced by each element in the collection responsive to the first light; generating second image data that changes responsively to an amount of second light reflected or transmitted by each element within the collection; and processing at least the first image data and the second image data to identify any undesired elements within the collection.

In some embodiments, illuminating the collection with first light is performed at a different time to illuminating the collection with second light; and processing at least the first image data and the second image data comprises: combining the first image data and the second image data to form first combined image data; and processing the first combined image data to identify any undesired elements within the collection.

Combining the first image data and the second image data may comprise overlaying the second image data over the first image data or vice versa.

In some examples, the first wavelength band is an ultraviolet wavelength band.

In some examples, the second wavelength band is a visible light wavelength band.

The method may further comprise illuminating the collection with third light in a third wavelength band, different to the second wavelength band, the third light causing at least one third undesired element of the collection, different to any second undesired element of the collection, to transmit or reflect the third light differently than any desired element of the collection; and generating third image data that changes responsively to an amount of third light reflected or transmitted by each element within the collection, wherein processing at least the first image data and the second image data comprises processing at least the first image data, the second image data, and the third image data to identify any undesired elements within the collection.

Optionally, illuminating the collection with first light is performed at a different time to illuminating the collection with second light; illuminating the collection with third light is performed at the different time to illuminating the collection with first light and at a different time to illuminating the collection with second light; and processing at least the first image data and the second image data comprises: combining the first image data, the second image data, and the third image data to form second combined image data; and processing the second combined image data to identify any undesired elements within the collection.

Combining the first image data, the second image data, and the third image data may comprise overlaying the first image data, the second image data, and the third image data over the top of one another to produce the combined image data.

The third wavelength band may be an infrared wavelength band. In some examples, the third wavelength band is a short-wavelength infrared wavelength band.

In some examples, the first image data comprises a first two-dimensional image and the second image data comprises a second two-dimensional image.

Processing at least the first image data and the second image data to identify any undesired elements within the collection may comprise processing at least the first image data and the second image data to identify the representation of any element in the collection of one or more elements in the first image data and/or the second image data; and processing the first image data and the second image data to determine, for each identified representation of any element, whether or not the representation is of an undesired element.

Generating the first image data may comprise: capturing, as first captured light, light that includes at least a portion of fluorescent light emitted by any element in the collection as a result of illuminating the collection with first light; and generating first image data that represents the first captured light.

Generating the second image data may comprise: capturing, as second captured light, light that includes at least a portion of second light reflected or transmitted by any element in the collection as a result of illuminating the collection with second light; and generating second image data that represents the second captured light.

There is also provided a detection system comprising: a collection support configured to support a collection of one or more elements; at least one light source configured to: illuminate the collection supported by the collection support with first light in a first wavelength band, the first light causing a level of fluorescence in at least one first undesired element of the collection that is different than a level of fluorescence in any desired element of the collection; and illuminate the collection supported by the collection support with second light in a second wavelength band, the second light causing at least one second undesired element of the collection to transmit or reflect the second light differently than any desired element of the collection; at least one image sensor configured to: generate first image data that changes responsively to an amount of fluorescent light produced by each element in the collection responsive to the first light; and generate second image data that changes responsively to an amount of second light reflected or transmitted by each element within the collection; a computer device comprising: at least one processor; and at least one non-transitory computer-readable storage medium storing instructions thereon that, when executed by the at least one processor, cause the at least one processor to process at least the first image data and the second image data to identify any undesired elements within the collection.

The at least one light source may comprise: a first light source configured to generate the first light; and a second light source, separate to the first light source, configured to generate the second light.

The at least image sensor may comprise: a first image sensor configured to generate the first image data; and a second image sensor, separate to the first image sensor, configured to generate the second image data.

The at least one image sensor may comprise an image sensor positioned to receive reflections of the second light by each element within the collection.

The at least one image sensor may comprise only at least one image sensor that operates a visible light spectrum.

There is also provided a sorter device comprising any herein disclosed detection system; an element expulsion device configured to controllably expel elements from the collection of one or more elements; and a system controller configured to control the operation of the element expulsion device to expel any identified undesired elements from the collection.

Other technical features may be readily apparent to one skilled in the art from the following figures, descriptions, and claims.

Within the scope of this application, it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE SEVERAL VIEWS OF THE DRAWINGS

While the specification concludes with claims particularly pointing out and distinctly claiming what are regarded as embodiments of the present disclosure, various features and advantages may be more readily ascertained from the following description of example embodiments when read in conjunction with the accompanying drawings, in which:

FIG. 1 shows a sorter device according to one or more embodiments of the present disclosure;

FIG. 2 shows a proposed method of identifying undesired elements within a collection of one or more elements according to one or more embodiments of the disclosure;

FIG. 3 shows another proposed method of expelling any undesired elements from a collection of one or more elements;

FIG. 4 shows an example fake color image generated according to one or more embodiments of the present disclosure;

FIG. 5 shows a graph indicating the wavelengths of color capture within image data according to one or more embodiments of the present disclosure; and

FIG. 6 shows a computer device according to embodiments of the present disclosure.

### DETAILED DESCRIPTION

Illustrations presented herein are not meant to be actual views of any particular sorter device, detection system, expulsion device, component, or system, but are merely idealized representations that are employed to describe embodiments of the disclosure. Additionally, elements common between figures may retain the same numerical designation for convenience and clarity.

The following description provides specific details of embodiments. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all the elements that form a complete structure or assembly. Only those process acts and structures necessary to understand the embodiments of the disclosure are described in detail below. Additional conventional acts and structures may be used. The drawings accompanying the application are for illustrative purposes only, and thus may not be drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, any relational term, such as “first,” “second,” etc., is used for clarity and convenience in understanding the disclosure and accompanying drawings, and does not connote or depend on any specific preference or order, except where the context clearly indicates otherwise.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

As used herein, the term “and/or” includes any and all combinations of one or more of the associated listed items.

As used herein, the term “intensity” when used in reference to light, refers to one or more of a radiometric quantity measured in watts per steradian (W/sr), a photometric quantity measured in lumens per steradian (Im/sr), or candela (cd), or a radiometric quantity, measured in watts per square meter (W/m²).

In the context of the present disclosure, ultraviolet light may be defined as light having a wavelength of from 1 nm to 380 nm, visible light may be defined as light having a wavelength of 380 nm to 780 nm, infrared light may be defined as light having a wavelength of from 780 nm to 106 nm. However, other suitable definitions will be apparent to the skilled person.

Embodiments include sorter devices having one or more light sources and one or more image sensors for identifying the presence and/or location of undesired elements within a collection of elements (carried by the sorter device). Embodiments comprise using image data produced by the image sensor(s) to perform such identification. This identification can be used, for instance, to control the expulsion of any undesired elements from a collection of elements.

The embodiments of sorter devices and the methods described herein may provide advantages over conventional sorter devices and methods. In particular, a conventional sorter device will aim to distinguish undesired elements from desired elements. However, some undesired elements closely resemble (e.g., in color, shape or other properties) desired elements, making it difficult to distinguish undesired from desired elements. This can lead to erroneous sorting of a collection of elements, e.g., erroneous labelling of an undesired element as a desired element. Proposed techniques facilitate more accurate identification of undesired elements can be achieved and/or increase the number of different types of undesired element that can be identified within a single sorting device. This can reduce error in sorting and reduce a risk of contaminating a collection (e.g., including desired elements) with undesired elements. This is particularly advantageous if an undesired element is a contaminated or infected element (such as a contaminated grain).

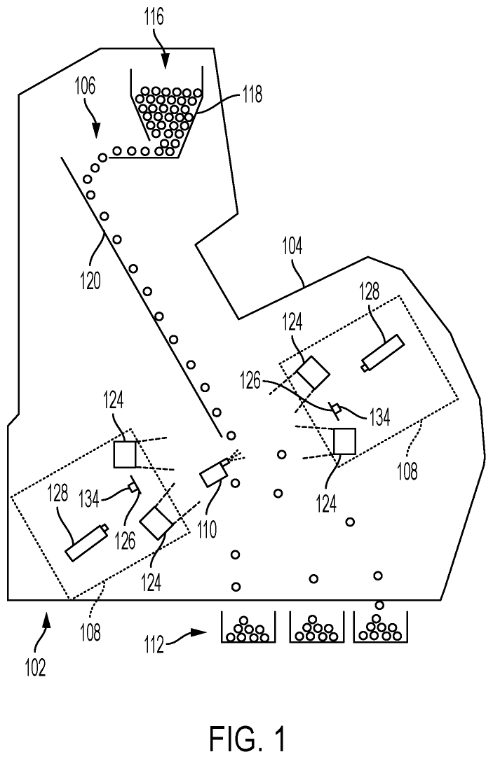

FIG. 1 shows a sorter device 102 in which one or more proposed embodiments can be employed.

The sorter device 102 may include a support frame 104 supporting an infeed system 106, at least one detection system 108, at least one element expulsion device 110, and a plurality of collection bins 112. The infeed system 106 may effectively act as a collection support for supporting and/or maneuvering a collection of one or more elements (to be sorted).

As is described in greater detail below, the sorter device 102 may be utilized to sort a collection 116 of elements (i.e., a bulk product of granular product) such as, for example, nuts, seeds, grain, plastic pieces, etc. The sorter device 102 may be configured sort the collection of elements (which may interchangeably be hereinafter referred to as “grains”) based on one or more of the elements' sizes, shapes, colors, types, chemical characteristics, or materials. In particular, the sorter device 102 may sort the elements of the collection 116 according to preselected sorting criteria. As a non-limiting example, the sorter device 102 may be utilized to sort grain based on quality of the grain, which, in some instances, may be determined by a color of the grain. As another non-limiting example, the sorter device 102 may be utilized to sort a collection of plastic pieces based on plastic type.

The infeed system 106 of the sorter device 102 may include a hopper 118 and a chute and/or belt 120. The hopper 118 may define a pathway to the chute and/or belt 120, and in some embodiments, the hopper 118 may include one or more vibrators (e.g., a vibrator feeder), augers, or other feeders to feed the collection 116 of elements from the hopper 118 to the chute and/or belt 120. The chute and/or belt 120 may be sized, shaped, and oriented to cause the collection 116 of elements to descend due to gravity and/or a conveyor belt in order to pass in front of the at least one detection system 108. For instance, the chute and/or belt 120 may be configured to produce a stream 122 of elements in the collection to pass in front of the at least one detection system 108 according to a selected velocity (e.g., speed).

The detection system 108 may include at least one light source 124 and at least one image sensor 128. The detection system 108 may also comprise a computer device (not shown). The detection system may comprise one or more background elements 126 and/or one or more reference elements 134.

The at least one light source is configured to illuminate the collection 116 of elements as it passes in front of the detection system 108. For example, the at least one light source 124 may include one or more light-emitting-diodes (LEDs) for emitting light.

The at least one light source 124 is configured to emit (at least) two different types of light, e.g., falling within two different wavelength bands. The light source may therefore emit two or more of: visible light, short-wave infrared light (SWIR light), near infrared light (NIR light), infrared (IR) light, or ultra-violet (UV) light. In one or more embodiments, the at least one light source is configured to separately emit light within two or more specific (e.g., selected) spectral band of the electromagnetic spectrum.

The one or more image sensors 128 may include one or more of a charged-coupled device (CCD) camera, an IR camera, a UV camera, or an RGB camera. During use, the one or more image sensors 128 may be oriented and configure to detect (e.g., capture) light reflected from (at least a portion of) the collection 116, transmitted through the collection and/or fluoresced by the collection as a result of an illumination of the collection by light produced by the at least one light source 124. For instance, the field(s) of views of the one or more image sensors 128 may include at least a portion of a stream 122 of the collection 116.

In one or more embodiments, the detection system 108 may further include one or more optical filters for filtering (e.g., narrowing) the light being detected (e.g., captured) by the one or more image sensors 128. In some embodiments, the one or more optical filters may narrow the reflected light into specific (e.g., selected) wavelengths that may accentuate sorting criteria (e.g., criteria distinguishing grades or types of bulk products).

The computer device of the detection system 108 is configured to process image data produced by the image sensor(s) 128 to identify any undesired elements. In particular, the computer device may receive image data from the at least one image sensor 128 and analyze the image data to identify any undesired elements in the collection 116.

The computer device may comprise at least one processor and at least one non-transitory computer-readable storage medium storing instructions thereon that, when executed by the at least one processor, cause the at least one processor to process image data to identify any undesired element(s).

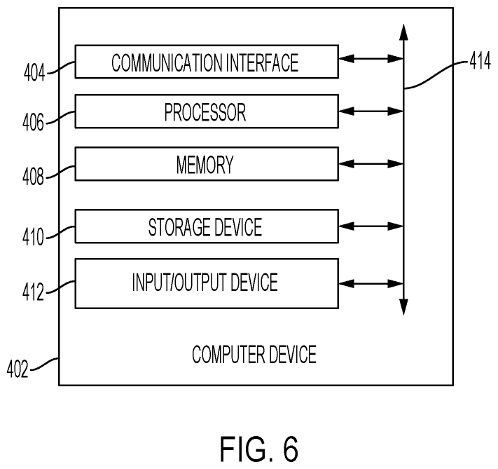

A suitable example of a computer device for the detection system 108 is described, later in this disclosure, in greater detail with reference to FIG. 6.

As previously mentioned, the detection system 108 may include one or more background elements 126. The one or more background elements 126 may be disposed and oriented behind the collection 116 relative to the one or more image sensors 128, i.e., from the viewpoint of the one or more image sensors. The background elements 126 aim to provide better detection and imaging of the individual grains of the bulk product 116. The one or more background elements 126 may include any known background elements used in sorter devices.

As noted above, the at least one detection system 108 may include one or more reference elements 134. Each reference element 134 may be disposed within a field of view of the at least one image sensor 128. In some embodiments, each reference element 134 may have an at least substantially constant color and/or may exhibit an at least substantially constant color. As a non-limiting example, each reference element 134 may include a colored piston within a clear cylinder where a center of the colored piston (e.g., a reference area) is protected from contamination (e.g., dust and discoloration) via one or more gaskets. The sorter device 102 may utilize the plurality of reference elements 134 as a reference point for light perceived by the detection system 108.

The at least one expulsion device 110 may be operably coupled to and at least partially operated by a system controller 114. In particular, the system controller 114 may generate control signals for the at least one element expulsion device 110 based at least partially on the analysis of the image data by the computer device of the detection system 108.

In some examples, the infeed system 106 is similarly operably coupled to and at least partially operated by a system controller 114. For example, the system controller 114 may provide control signals to the infeed system 106 to cause the infeed system 106 to feed the collection 116 of elements to the chute and/or belt 120 of the sorter device 102 and to cause the chute and/or belt 120 of the sorter device 102 to generate a stream of the bulk product 116.

The system controller and the computer device of the detection system may be integrated into a single component. In practice, this means that a single computer device may perform the functions of the system controller and the computer device of the detection system.

The present disclosure proposes a new technique for identifying undesired elements in a collection of elements. This approach can, for instance, be useful for identifying which elements in a collection of elements contained within a sorter device are to be expelled by the element expulsion system(s) of the sorter device.

More particularly, the present disclosure provides a mechanism for identifying any one or more undesired elements within a collection of elements. First image data of the collection of elements is produced responsive to fluorescence resulting from light in a first wavelength band. Second image data of the collection is produced responsive to reflected/transmitted light in a second wavelength band. The first and second image data is processed to identify the any one or more undesired elements.

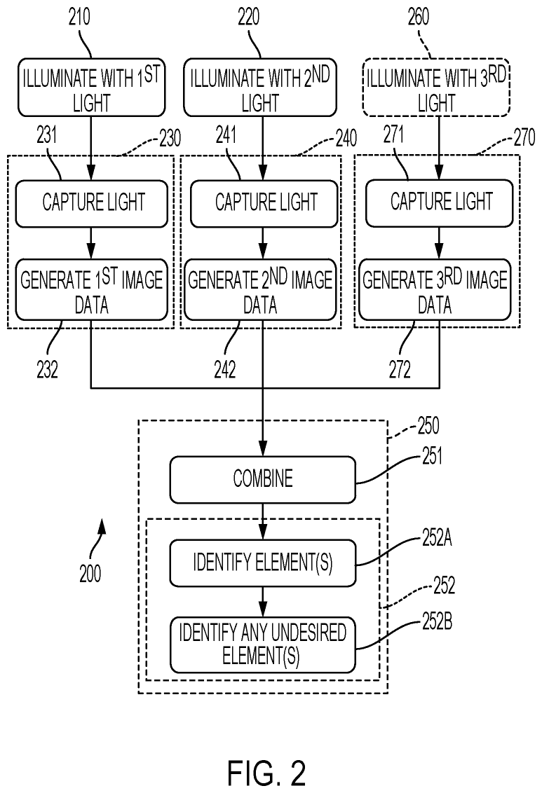

FIG. 2 is a flowchart that illustrates a method 200 for identifying any undesired elements within a collection of one or more elements. This method may be performed by a sorter device, such as the previously described sorter device, in order to identify any undesired elements. More particularly, the method 200 may be performed by a previously described detection system.

The method 200 may include illuminating the collection with first light in a first wavelength band, as shown in act 210 of FIG. 2. As a non-limiting example, illuminating the collection with first light in a first wavelength band may include illuminating the collection with the at least one light source 124 of the sorter device 102. The first wavelength band of the first light is selected or chosen such that the first light causes a different level of fluorescence in at least one first undesired element than in any desired element. Thus, the first wavelength band of the first light may be selected or chosen to cause a known subset of undesired elements (e.g., a single type of undesired elements), when illuminated with the first light, to fluoresce.

As a first working example, the first light may include ultraviolet (UV) light, e.g., may only include ultraviolet light. Ultraviolet light causes different levels of (e.g., visible light) fluorescence in: contaminated/moldy/infected grains (i.e., grains with contaminates such as aflatoxins) compared to healthy grains; grains having different levels of gluten; different genera of grain (e.g., different genera of oat grains) and so on. This can allow for distinguishing between elements having such different properties.

As a second working example, the first light may include red light, e.g., may only include red light. Red light causes chlorophyll to fluoresce (e.g., fluoresce infrared light). Thus, elements with different amounts of chlorophyll will fluoresce differently to such first light, e.g., cause different levels of fluorescence. This can allow for distinguishing between: organic and inorganic elements, grain and non-grain elements (e.g., leaves), and so on.

The method 200 may also include illuminating the collection with second light in a second wavelength band, as shown in act 220 of FIG. 2. As a non-limiting example, illuminating the collection with second light in a second wavelength band may include illuminating the collection with the at least one light source 124 of the sorter device 102. The second light is configured such that at least one second undesired element transmits or reflects the second light differently to any desired element. The second light may, for instance, include visible light. Thus, the second light may be light that is reflected/transmitted differently by different elements. This allows for distinguishing, for instance, between elements of different colors, shapes, patterns etc.

Acts 210 and 220 may be performed using one or more light sources of a detection system. In particular, the illuminating with first light may be performed using a first light source and the illuminating with second light may be performed by a second, different light source.

The method 200 may also include generating first image data that changes responsively to an amount of fluorescent light produced or emitted by each element in the collection responsive to the first light, as shown in act 230 of FIG. 2. Thus, the values of the first image data are different for different amounts or levels of fluorescent light produced by the element(s) of the collection. The act 230 can be performed using (the) at least one image sensor.

The first image data may, for instance, be a first two-dimensional image. Techniques for generating a two-dimensional image are well known.

The wavelength(s) of the fluorescent light may be known in advance, e.g., due to known fluorescence properties of the undesired element(s) or desired element(s). The image sensor(s) used to produce the first image data may be appropriately designed to capture light in the particular wavelength(s) in which fluorescent light emitted by an undesired element or desired element is expected. This facilitates distinguishing of any undesired elements from desired elements.

The act 230 may be performed by producing light sensitive signals using the at least one image sensor, i.e., capturing an image using the at least one image sensor. The image sensor(s) is/are configured to be sensitive to (any) fluorescent light that is produced or emitted by each element in the collection as a result of being illuminated with the first light.

In this way, the first image data is sensitive to different levels of fluorescence emitted by any elements in the collection (as a result of illuminating the collection with the first light). Thus, the first image data is configured such that it is possible to distinguish between different levels of fluorescence by any element within the imaged collection of elements. Put another way, the first image data will change or be different for different levels and/or amounts of fluorescent light emitted by any element in the collection of one or more elements that has been illuminated with the first light.

Act 230 may, for instance, comprise an act 231 of capturing, a first captured light, light that includes at least some of any fluorescent light emitted by any element in the collection. Thus, acts 231 comprises capturing, as first captured light, light that includes at least a portion of fluorescent light emitted by any element in the collection as a result of illuminating the collection with first light. More particularly, act 231 may comprise capturing any such light using the at least one image sensor 128.

Act 230 may also comprise an act 232 of producing or generating the first image data that represents the first captured light, i.e., the light captured in act 231. Act 232 may similarly be performed by the at least one image sensor and/or circuitry connected thereto, which is configured to generate image data responsive to captured light. Mechanisms for converting captured light to produce image data are well known and established in the art.

The method 200 may also include generating second image data that changes responsively to an amount of second light reflected or transmitted by each element within the collection, as shown in act 240 of FIG. 2. This can be performed using (the) at least one image sensor. The second image data is therefore responsive to reflected/transmitted light in the second wavelength band.

The second image data may, for instance, be a second two-dimensional image. Techniques for generating a two-dimensional image are well known.

The second image data may include (e.g., only) image data responsive to an amount of second light reflected by each element within the collection. This may be achieved using an image sensor that is positioned to receive (e.g., only) second light reflected by the collection, and not transmitted light. For instance, the image sensor(s) used may be positioned at a same side of the collection as the light source used to produce the second light, such that the second light is reflected off the collection and into the image sensor(s).

In other examples, the second image data may include (e.g., only) image data responsive to an amount of second light transmitted by each element within the collection. This may be achieved using an image sensor that is positioned to receive (only) second light reflected by the collection, and not transmitted light. For instance, the image sensor(s) used may be positioned at an opposite side of the collection as the light source used to produce the second light, such that the second light is transmitted through the collection and into the image sensor(s).

These approaches recognize that an undesired element may have a different reflective/transmissive property to a desired element. For instance, one undesired element may absorb more light than any desired element. As another example, one undesired element may be a different color than a desired element. As another example one desired element may transmit more light (e.g., be less absorptive) than a desired element.

The act 240 may be performed by producing light sensitive signals using the at least one image sensor, i.e., capturing an image using the at least one image sensor. The image sensor(s) is/are configured to be sensitive to (any) light that is reflected or transmitted by each element in the collection as a result of being illuminated with the second light.

In this way, the second image data is sensitive to different levels of reflected/transmitted second light by any elements in the collection (as a result of illuminating the collection with the second light). Thus, the second image data is configured such that it is possible to distinguish between different levels of reflectance/transmittance by any element within the imaged collection of elements. Put another way, the second image data will change or be different for different levels and/or amounts of second light transmitted/reflected by any element in the collection of one or more elements that has been illuminated with the second light.

Act 240 may, for instance, comprise an act 241 of capturing, as second captured light, light that includes at least some of any second light transmitted or reflected emitted by any element in the collection. Thus, the second captured light includes at least a portion of second light reflected or transmitted by any element in the collection as a result of illuminating the collection with second light. More particularly, act 241 may comprise capturing any such light using the at least one image sensor 128.

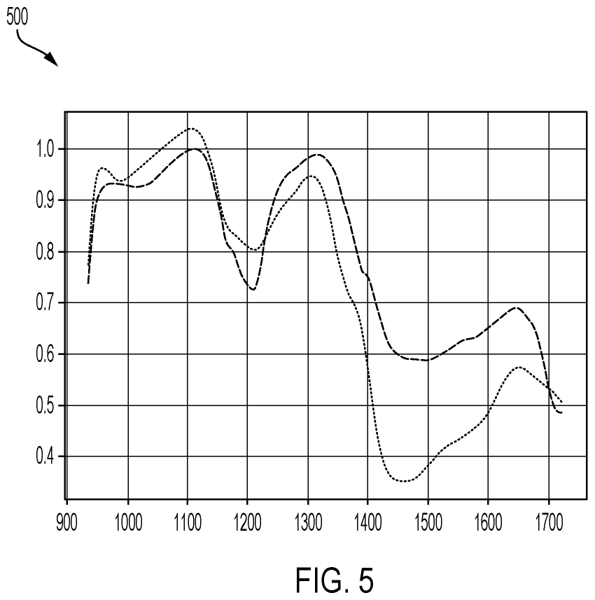

Act 240 may also comprise an act 242 of producing or generating the second image data that represents the light captured in act 241. Act 242 may similarly be performed by the at least one image sensor and/or circuitry connected thereto, which is configured to generate image data responsive to captured light. Mechanisms for converting captured light to produce image data are well known and established in the art. In some embodiments, producing or generating the second image data may include generating a true color image (e.g., a matrix of RGB pixel where R is equivalent to red, G is equivalent to green, and B is equivalent to blue. IN additional embodiments, the producing or generating the second image data may include generating a fake color image where the R, G, and B channels reflect specific wavelengths of light (e.g., invisible to the naked eye colors). As a non-limiting example, the R-channel could be selected as 1200 nm light, the B-channel could be selected as 1000 nm light, and the G-channel could be selected as 1400 nm light. FIG. 4 shows an example fake color image 400a that can be produced via the methods described herein. Furthermore, FIG. 5 shows a graph 500 depicting the wavelengths of light included in the second image data according to one or more embodiments.

From the foregoing, it will be clear that the image sensor(s) used to perform acts 230, 240 may be adapted to be sensitive to the appropriate wavelength bands. For instance, the image sensor(s) may include a first image sensor for producing the first image data, the first image sensor being sensitive to light in a wavelength band in which an undesired element is expected to fluoresce. The image sensor(s) may further include a second image sensor for producing the second image data, the second image sensor being sensitive to light in the second wavelength band.

The first and second image data may be produced separately to one another, e.g., not at the same time by a same image sensor. Rather, the first and second image data may be produced at different points in time and/or by different image sensors. In some examples, acts 210 and 220 are therefore not performed at the same time. Rather, acts 210 and 220 may be performed at different times. In particular, acts 210 and 220 may be temporally multiplexed with respect to one another (e.g., to alternative between performing act 210 and act 220).

Alternatively, the first and second image data may be produced at a same point in time, e.g., to directly produce combined image data. This can be achieved, for instance, by illuminating the collection with first and second light simultaneously and capturing the first and second image data using the same image sensor or separate image sensors. By way of example, an image sensor 128 may be a multi-spectral image sensor that simultaneously generate the first and second image data.

The method 200 also includes processing at least the first image data and the second image data to identify any undesired elements within the collection, as shown in act 250 of FIG. 2. More particularly, the act 250 of processing may include identifying the location of any undesired elements within the collection.

Approaches for processing image data to identify unidentified elements are known in the art. Generally, such approaches make use of image processing algorithms (e.g., including one or more segmentation algorithms or classification algorithms) to identify the presence of a representation of an unidentified element in the image data. An essential component to distinguishing an undesired element from a desired element using image data is that the representation of an undesired element should be distinguishable from a desired element. The use of first and second image data (produced from first and second light) in this way facilitates distinguishing of undesired element(s) from desired elements. In particular, by using two different forms of light to produce two different forms of image data, different undesired elements can be distinguished from desired elements.

With regard to the first image data, some seeds reflect fluorescence light, and some do not. Algorithms can thus be used on the gathered images to identify which seeds do not reflect fluorescence light (e.g., glow) and transform the original multilayered pictures into binary masks. Furthermore, as is discussed herein, the seeds can be sorted based on whether or not the seeds reflect fluorescence light. Each bit of the binary mask then indicates whether the ejectors have to discard the seed corresponding to that pixel or not. The position in the image of the pixel at the location to be discarded translates to coordinates in real space, hence a real position and time at which to open the air jet and reject the object that is passing by. This approach may be applied to different sorting machines, for example with a conveyor belt instead of a slide, and mechanical ejectors or levers instead of air ejectors.

Algorithms can be used to differentiate between seeds that reflect fluorescence light, and those that do not. In some embodiments, the algorithms may differentiate between seed based at least partially on color thresholds. Shapes may be formed around the colors, using an algorithm that detects edges and contours, to be saved in an n-dimensional space (e.g., not only RGB but also other parts of the spectrum such as IR or UV). Anomaly detection is, for example, based on rejecting everything that is too different from an intended target. This can be performed in an automated way using cluster detection, whereby a classifier or neural network is trained to perform the analysis. This may be able to distinguish between elements even when an operator is not able to see the differences or detect them with standard tools such as analysis of histograms of the data.

The precise criteria that distinguishes an undesired element from a desired element will be dependent upon the specific use case for the method. As outlined above, known criteria that could be used include a color, intensity or appearance of an element within the image data. Thus, an image processing algorithm may search for particular colors or intensities within an image data to identify any undesired elements.

Thus, it will be appreciated that the precise procedure for performing act 250 may be dependent upon the type or identity of the undesired element(s) and the desired element(s).

As a working example only, if there is a desire to identify (as undesired elements) barley and wheat grains within a collection of elements including oat grains (as desired elements), then barley grains can be identified by identifying grain that fluoresces (from the first image data) and the wheat grains can be identified by identifying orange grain (from the second image data). Fluorescing elements can be identified based on their color and/or intensity (e.g., having an intensity above a particular value at a particular known fluorescing color).

One approach for processing image data to identify any undesired elements is to identify any regions that meet one or more predetermined criteria, e.g., having a particular color, intensity and so on. The precise criteria will depend upon the nature of the undesired element. Each identified region (e.g., above a predetermined size) may represent a respective undesired element.

Another approach for processing image data to identify any undesired elements is to use one or more machine-learning methods. The image data may be received, as input, to the machine-learning method which provides, as output, an indicator of the presence of any undesired elements. The indicator may take the form of a binary indicator, a probability and/or location or segmentation information that identifies the location of any undesired elements within the image data.

Some embodiments therefore make use of one or more machine-learning algorithms. Any suitable machine-learning algorithm may be used in different embodiments for the present disclosure. Suitable machine-learning algorithms include (artificial) neural networks, support vector machines (SVMs), Naïve Bayesian models and decision tree algorithms, although other appropriate examples will be apparent to the skilled person.

There are a number of well-established approaches for training a machine-learning algorithm. Typically, such training approaches make use of a large database of known input and output data. The machine-learning algorithm is modified until an error between predicted output data, obtained by processing the input data with the machine-learning algorithm, and the actual (known) output data is close to zero, i.e., until the predicted output data and the known output data converge. The value of this error is often defined by a cost function. The precise mechanism for modifying the machine-learning algorithm depends upon the type of model. Example approaches for use with a neural network include gradient descent, backpropagation algorithms and so on.

For use in the above-described approach, the known input data includes image data (e.g., combined image data). The corresponding known output data includes, for each example instance of image data, an indicator of the presence of any undesired element. The indicators may be prepared or produced by an appropriately skilled person.

In some preferred examples, the act 210 of illuminating with first light is performed at a different point in time to the act 220 of illuminating with second light. This avoids cross-contamination between the generation of the first and second image data.

In some examples, the act 250 of processing 250 includes an act 251 of combining the first image data and the second image data to produce combined image data. Thus, the first and second image data may be merged to form the combined image data. Combining can be performed by, for instance, overlaying the first image data over the second image data (or vice versa). One alternative to overlaying is to stack the first image data with the second image data to create combined image data.

As previously mentioned, the first image data and the second image data are produced using different forms of light (first light and second light respectively). Accordingly, act 251 effectively produces combined image data using separate data sources.

In some examples, the first image data is a first two-dimensional image, and the second image data is a second two-dimensional image.

In one example, act 251 can be simply performed by overlaying the first two-dimensional image over the second two-dimensional image. An act of overlaying can be readily performed, for instance, by correlating each pixel of the first two-dimensional image to a pixel of the second two-dimensional image and then (for each pair of correlated pixels) summing, averaging or otherwise algorithmically processing the pixel value(s) together to produce a combined image. Alternatives to summing or averaging include multiplying, dividing or performing a weighted combination (e.g., weighted sum, weighting multiplication etc.).

In another example, act 252 can be performed by stacking the first two-dimensional image over the second two-dimensional image, e.g., to create a three-dimensional image.

In some examples, the first image data is generated using a first image sensor and using first light generated by a first light source. The second image data may similarly be generate using a second image sensor (separate to the first image sensor) using second light generated by a second light source (separate to the first light source). In this way, the first image data and the second image data may be produced using separate or different data sources. Act 251 thereby combines image data from two separate data sources to be further processed together.

As a working example, the first image data may be a fluorescent image and the second image data may be (visible) color image or a fake color SWIR image. The two images may be combined together, e.g., by performing a summation of corresponding/correlated pixels, to produce a single combined image.

The processing 250 may then perform an act 252 of processing the combined image data to identify any undesired elements within the collection. Producing combined image data increase the computational efficiency of processing data and reduces an amount of storage space required. Combining the first and second image data may also facilitate more nuanced identification of undesired elements, e.g., to include a criterion that an undesired element should have a certain appearance when the image data is combined such as a certain color.

Approaches for processing image data to identify any undesired elements within the collection have been previously described.

One approach to performing act 252 is to process the combined image data to first identify the representation of any element (in the collection) within the combined image data, as represented by act 252A of FIG. 2. Act 232A may, for instance, be performed by processing the combined image data using a segmentation algorithm to segment or identify any elements represented in the combined image data.

Act 252 may then perform an act 252B of processing each identified representation to determine or predict whether the representation is of a desired element or an undesired element. This may comprise determining whether or not the representation of the identified element meets one or more predetermined criteria, which criteria will depend upon the precise nature of the undesired element (e.g., a certain color above a certain intensity).

FIG. 2 also illustrates further optional steps of the method 200.

The method 200 may further include illuminating the collection with third light in a third wavelength band, different to the second wavelength band, as shown in act 260 of FIG. 2. The third light is configured such that at least one third undesired element, different to any second undesired element, transmits or reflects the second light differently to any desired element.

Thus, the third light is configured such that at least one third undesired element transmits or reflects the third light differently to any desired element. The third undesired element(s) may transmit/reflect the second light in the same manner or non-distinguishably as a desired element. Thus, the third light may facilitate distinguishing of at least one undesired element from any desired element that was not previously possible using the first/second light.

For instance, some species of wheat are yellow. For these species, it is not currently possible to accurately distinguish (yellow) wheat grain from oat grain using color (i.e., visible light reflections) or fluorescent properties alone. However, wheat gain responds differently to infrared light than oat gain (e.g., has different reflective properties in the infrared spectrum).

Example approaches for producing image data that is responsive to (only) reflected or transmitted light have been previously described in the context of the second image data. The same understanding can be applied to the third image data, and the relevant procedures (e.g., positioning of the image sensor(s)) can be adapted accordingly. Such examples are not repeated for the sake of conciseness.

The third wavelength band may, for instance, be an infrared wavelength band, e.g., a short-wavelength infrared wavelength band. A short-wavelength infrared band is generally defined as a wavelength band of from 800 nm to 3000 nm, e.g., 1000 nm to 3000 nm, e.g., or 1400 nm to 3000 nm.

The method 200 may include generating third image data that changes responsively to an amount of third light reflected or transmitted by each element within the (illuminated) collection, as shown in act 270 of FIG. 2. This can be performed using (the) at least one image sensor. The third image data may, for instance, be a third two-dimensional image. Techniques for generating a two-dimensional image are well known.

The third image data is therefore responsive to reflected/transmitted light in the third wavelength band.

The act 250 of processing at least the first image data and the second image data may include processing at least the first image data, the second image data, and the third image data to identify any undesired elements within the collection. The processing may, for instance, include an act 251 of combining the first, second and third image data together to produce (second) combined image data. The method may then include an act 252 of processing the (second) combined image data to identify any undesired elements within the collection.

The act 270 may be performed by producing light sensitive signals using the at least one image sensor, i.e., capturing an image using the at least one image sensor. The image sensor(s) is/are configured to be sensitive to (any) light that is reflected or transmitted by each element in the collection as a result of being illuminated with the third light.

In this way, the third image data is sensitive to different levels of reflected/transmitted third light by any elements in the collection (as a result of illuminating the collection with the second light). Thus, the third image data is configured such that it is possible to distinguish between different levels of reflectance/transmittance by any element within the imaged collection of elements. Put another way, the third image data will change or be different for different levels and/or amounts of third light transmitted/reflected by any element in the collection of one or more elements that has been illuminated with the third light.

Act 270 may, for instance, comprise an act 271 of capturing, as third captured light, light that includes at least some of any third light transmitted or reflected emitted by any element in the collection. Thus, the third captured light includes at least a portion of third light reflected or transmitted by any element in the collection as a result of illuminating the collection with third light. More particularly, act 271 may comprise capturing any such light using the at least one image sensor 128.

Act 270 may also comprise an act 272 of producing or generating the third image data that represents the light captured in act 271. Act 272 may similarly be performed by the at least one image sensor and/or circuitry connected thereto, which is configured to generate image data responsive to captured light. Mechanisms for converting captured light to produce image data are well known and established in the art.

Proposed embodiments are particularly advantageous when the first light includes ultraviolet light, the second light includes visible light and the third light includes infrared (IR) light, e.g., short-wave infrared (SWIR) light. This provides a good range of different characteristics that facilitate distinguishing a wide variety of different element (particularly different organic elements such as different grains) from one another.

In any above-described embodiment, the output of the method 200 may be information identifying the presence and/or location(s) of any undesired element in the illuminated collection of one or more elements. This may, for instance, take the form of annotated image data (e.g., for identifying the location of the elements) and/or binary data (e.g., identifying the presence and/or absence of any undesired element(s)). The correspondence between a location in image data (e.g., of an undesired element) and the location within a real space may be known, e.g., as a result of a known/predetermined location of the image sensor(s) capturing the image data to be processed.

It has previously been identified that it is possible to expel undesired element(s) from a collection of one or more element(s) using one or more element expulsion system(s) of a sorter device.

However, it will be appreciated that this is not an essential step. By way of example, the presence of any undesired element could be monitored using method 200, e.g., to determine whether the collection of one or more elements is contaminated. This can be used to determine whether the entirety of the collection of one or more elements needs to be discarded.

Although above-described examples demonstrate only up to three instances of image data (corresponding to three different forms of light), the skilled person will appreciate that embodiments may include more than three instances of image data for more than three different forms of light. Thus, N instances of image data may be produced for N forms of light illuminating the collection of one or more elements, where N is an integer value greater than or equal to 2. Each of the N forms of light may be light in a different or distinct wavelength band. The N instances of image data may be processed to identify any undesired elements. For instance, the N instances of image data may be combined to form combined image data, which may then be processed to identify any undesired elements.

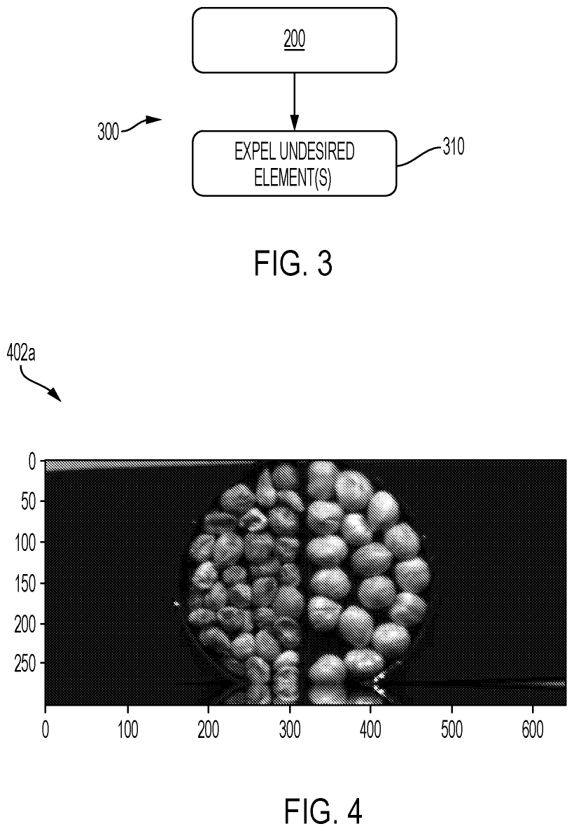

FIG. 3 is a flowchart illustrating a method 300 of expelling any undesired elements from a collection of one or more elements.

The method 300 includes performing the method 200 for identifying any undesired elements within the collection. The method 300 also includes an act 310 of expelling any identified undesired element. Approaches for expelling an element from a collection of elements are well known in the art, and may include (for instance), using pneumatic ejectors, air nozzles and so on.

FIG. 6 is a schematic view of a computer device 402. In some embodiments, a detection system 108 may include a computer device such as the computer device 402 of FIG. 6. The computer device 402 may include a communication interface 404, at least one processor 406, a memory 408, a storage device 410, an input/output device 412, and a bus 414.

In some embodiments, the processor 406 includes hardware for executing instructions, such as those making up a computer program. As an example, and not by way of limitation, to execute instructions, the processor 406 may retrieve (or fetch) the instructions from an internal register, an internal cache, the memory 408, or the storage device 410 and decode and execute them. In some embodiments, the processor 406 may include one or more internal caches for data, instructions, or addresses. As an example, and not by way of limitation, the processor 406 may include one or more instruction caches, one or more data caches, and one or more translation look aside buffers (TLBs). Instructions in the instruction caches may be copies of instructions in the memory 408 or the storage device 410.

The memory 408 may be coupled to the processor 406. The memory 408 may be used for storing data, metadata, and programs for execution by the processor(s). The memory 408 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 408 may be internal or distributed memory.

The storage device 410 may include storage for storing data or instructions. As an example, and not by way of limitation, storage device 410 can comprise a non-transitory storage medium described above. The storage device 410 may include a hard disk drive (HDD), Flash memory, an optical disc, a magneto-optical disc, magnetic tape, or a Universal Serial Bus (USB) drive or a combination of two or more of these. The storage device 410 may include removable or non-removable (or fixed) media, where appropriate. The storage device 410 may be internal or external to the computing storage device 410. In one or more embodiments, the storage device 410 is non-volatile, solid-state memory. In other embodiments, the storage device 410 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or Flash memory or a combination of two or more of these.

The input/output device 412 may allow an operator of the sorter device 102 to provide input to, receive output from, and otherwise transfer data to and receive data from computer device 402. The input/output device 412 may include a mouse, a keypad or a keyboard, a joystick, a touch screen, a camera, an optical scanner, network interface, modem, other known I/O devices, or a combination of such I/O interfaces. The input/output device 412 may include one or more devices for presenting output to an operator, including, but not limited to, a graphics engine, a display (e.g., a display screen), one or more output drivers (e.g., display drivers), one or more audio speakers, and one or more audio drivers. In certain embodiments, the input/output device 412 is configured to provide graphical data to a display for presentation to an operator. The graphical data may be representative of one or more graphical user interfaces and/or any other graphical content as may serve a particular implementation. The computer device 402 and the input/output device 412 may be utilized to display data (e.g., images and/or video data) regarding the sorting processes and adjustments to operating parameters of the light source(s) 124 and/or image sensors 128. The computer device 402 and the input/output device 412 may be utilized to

The communication interface 404 can include hardware, software, or both. The communication interface 404 may provide one or more interfaces for communication (such as, for example, packet-based communication) between the computer device 402 and one or more other computing devices or networks (e.g., a server). As an example, and not by way of limitation, the communication interface 404 may include a network interface controller (NIC) or network adapter for communicating with an Ethernet or other wire-based network or a wireless NIC (WNIC) or wireless adapter for communicating with a wireless network, such as a WI-FI.

In some embodiments, the bus 414 (e.g., a Controller Area Network (CAN) bus) may include hardware, software, or both that couples components of computer device 402 to each other and to external components.

All references cited herein are incorporated herein in their entireties. If there is a conflict between definitions herein and in an incorporated reference, the definition herein shall control.

The examples above describe first image data relating to fluorescence and second image data relating to reflection or transmission. However, the image data may be collected in either order. Thus, “first” and “second” are not intended to denote a temporal order. Furthermore, the image data may not include only a single type of light information. For example, there may be cases in which first light and second light both merge in a first generated image. In this case, RGB data may have a superimposed fluorescence response. The same may arise with multiple IR wavelengths. Different light contributions may merge by simple superposition like or by way of multiplexing.

For example, first image data may comprise RGB, and fluorescence information and the second image data may comprise only fluorescence information.

The first and second image data may also be different parts of a single image. In such a case, there may not be any second and third image. In some applications there may just be a color image or a fake color image (i.e., wavelength shifted RGB) to enable identification of where objects are located as a way of navigating the data, which can be a single multilayered image.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

1. A method for identifying undesired elements within a collection of one or more elements, the method comprising:
illuminating the collection with first light in a first wavelength band, the first light causing a level of fluorescence in at least one first undesired element of the collection that is different than a level of fluorescence in any desired element of the collection;
illuminating the collection with second light in a second wavelength band, the second light causing at least one second undesired element of the collection to transmit or reflect the second light differently than any desired element of the collection;
generating first image data that changes responsively to an amount of fluorescent light produced by each element in the collection responsive to the first light;
generating second image data that changes responsively to an amount of second light reflected or transmitted by each element within the collection; and
processing at least the first image data and the second image data to identify any undesired elements within the collection.

2. The method of claim 1, wherein:
illuminating the collection with first light is performed at a different time than illuminating the collection with second light; and
processing at least the first image data and the second image data comprises:
combining the first image data and the second image data to form first combined image data; and
processing the first combined image data to identify any undesired elements within the collection.

3. The method of claim 2, wherein combining the first image data and the second image data comprises overlaying the second image data over the first image data or overlaying the first image data over the second image data.

4. The method of claim 1, wherein the first wavelength band is an ultraviolet wavelength band.

5. The method of claim 1, wherein the second wavelength band is a visible light wavelength band.

6. The method of claim 1, further comprising:
illuminating the collection with third light in a third wavelength band, different to the second wavelength band, the third light causing at least one third undesired element of the collection, different than any second undesired element of the collection, to transmit or reflect the third light differently than any desired element of the collection; and
generating third image data that changes responsively to an amount of third light reflected or transmitted by each element within the collection,
wherein processing at least the first image data and the second image data comprises processing at least the first image data, the second image data, and the third image data to identify any undesired elements within the collection.

7. The method of claim 6, wherein:
illuminating the collection with first light is performed at a different time than illuminating the collection with second light;
illuminating the collection with third light is performed at the different time than illuminating the collection with first light and at a different time than illuminating the collection with second light; and
processing at least the first image data and the second image data comprises:
combining the first image data, the second image data, and the third image data to form second combined image data; and
processing the second combined image data to identify any undesired elements within the collection.

8. The method of claim 7, wherein combining the first image data, the second image data, and the third image data comprises overlaying the first image data, the second image data, and the third image data over one another to produce the combined image data.

9. The method of claim 1, wherein the third wavelength band is an infrared wavelength band.

10. The method of claim 9, wherein the third wavelength band is a short-wavelength infrared wavelength band.

11. The method of claim 1, wherein the first image data comprises a first two-dimensional image and the second image data comprises a second two-dimensional image.

12. The method of claim 1, wherein processing at least the first image data and the second image data to identify any undesired elements within the collection comprises:
processing at least the first image data and the second image data to identify a representation of any element in the collection of one or more elements in at least one of the first image data or the second image data; and
processing the first image data and the second image data to determine, for each identified representation of any element, whether or not the representation is of an undesired element.

13. The method of claim 1, wherein generating first image data comprises:
capturing, as first captured light, light that includes at least a portion of fluorescent light emitted by any element in the collection as a result of illuminating the collection with first light; and
generating first image data that represents the first captured light.

14. The method of claim 1, wherein generating second image data comprises:
capturing, as second captured light, light that includes at least a portion of second light reflected or transmitted by any element in the collection as a result of illuminating the collection with second light; and
generating second image data that represents the second captured light.

15. A detection system comprising:
a collection support configured to support a collection of one or more elements;
at least one light source configured to:
illuminate the collection supported by the collection support with first light in a first wavelength band, the first light causing a level of fluorescence in at least one first undesired element of the collection that is different than a level of fluorescence in any desired element of the collection; and
illuminate the collection supported by the collection support with second light in a second wavelength band, the second light causing at least one second undesired element of the collection to transmit or reflect the second light differently than any desired element of the collection;
at least one image sensor configured to:
generate first image data that changes responsively to an amount of fluorescent light produced by each element in the collection responsive to the first light; and
generate second image data that changes responsively to an amount of second light reflected or transmitted by each element within the collection; and
a computer device comprising:
at least one processor; and
at least one non-transitory computer-readable storage medium storing instructions thereon that, when executed by the at least one processor, cause the at least one processor to process at least the first image data and the second image data to identify any undesired elements within the collection.

16. The detection system of claim 15, wherein the at least one light source comprises:
a first light source configured to generate the first light; and
a second light source, separate to the first light source, configured to generate the second light.

17. The detection system of claim 15, wherein the at least image sensor comprises:
a first image sensor configured to generate the first image data; and
a second image sensor, separate to the first image sensor, configured to generate the second image data.

18. The detection system of claim 15, wherein the at least one image sensor comprises an image sensor positioned to receive reflections of the second light by each element within the collection.

19. The detection system of claim 15, wherein the at least one image sensor comprises only at least one image sensor that operates a visible light spectrum.

20. A sorter device comprising:
the detection system of any of claim 15;
an element expulsion device configured to controllably expel elements from the collection of one or more elements; and
a system controller configured to control operation of the element expulsion device to expel any identified undesired elements from the collection.
